(19) United States
(12) Patent Application Publication
(10) Pub. No.: US 2026/0340656 A1
(43) Pub. Date: Oct. 29, 2026

(54) Governance Evaluation and Determination Engine

(71) Applicants: Andrea Armstrong-Fields, Baltimore, MD (US); James Howard Fields, Baltimore, MD (US)

(72) Inventors: Andrea Armstrong-Fields, Baltimore, MD (US); James Howard Fields, Baltimore, MD (US)

(21) Appl. No.: 19/553,241

(22) Filed: Feb. 28, 2026

Related U.S. Application Data
(60) Provisional application No. 63/765,774, filed on Mar. 2, 2025.

(51) Int. Cl. G06Q 30/018; G06F 16/25

(52) U.S. Cl. CPC G06Q 30/018; G06F 16/258

(57) ABSTRACT

A governance evaluation architecture for controlling commit-capable state transitions in a computing environment is disclosed. A request associated with a commit-capable state transition is received and transformed into a structured intermediate representation independent of a native system data model. Contextual attributes associated with the request are incorporated into the structured intermediate representation, and version-identified governing criteria are machine-applied to the structured intermediate representation to generate a resolution state. The resolution state conditions completion, modification, or prevention of the commit-capable state transition and is materialized as a governance artifact configured for replay, audit, simulation, or subsequent enforcement. Because governance evaluation is performed on the structured intermediate representation rather than on native system data structures, the architecture is deployable in centralized, distributed, edge, cloud, inline, and out-of-band execution environments without modification of underlying application logic. The disclosed architecture provides deterministic, topology-independent control of state transitions across heterogeneous systems.

### CROSS-REFERENCE TO RELATED APPLICATIONS

This application claims the benefit of U.S. Provisional Patent Application No. 63/765,774, filed Mar. 2, 2025.

### FIELD OF THE INVENTION

The present disclosure relates to computer-implemented systems for machine-determined evaluation of data using governing criteria and for generation of topology-independent resolution states and governance artifacts across heterogeneous execution environments.

### BACKGROUND

Conventional rule-evaluation systems are typically implemented within specific application stacks and operate on native data models that are tightly coupled to particular execution environments. As a result, rule logic is duplicated across systems, governance outcomes are inconsistent, and deterministic replay or cross-system interoperability is not achievable.

### BRIEF SUMMARY OF THE INVENTION

A governance evaluation architecture is disclosed in which input data originating from one or more source systems is transformed into a structured intermediate representation that is independent of a native source data model. Contextual attributes are evaluated to select governing criteria applicable to at least a portion of the structured intermediate representation. Processing circuitry applies the governing criteria to produce a machine-determined resolution state and a machine-readable governance artifact.

### BRIEF DESCRIPTION OF THE DRAWINGS

FIG. 1 illustrates an example governance evaluation system including input sources, processing circuitry, memory, and a governance evaluation engine.

FIG. 2 illustrates transformation of input data into a structured intermediate representation.

FIG. 3 illustrates contextual attribute extraction and governing-criteria selection.

FIG. 4 illustrates rule evaluation and resolution-state generation.

FIG. 5 illustrates generation of a governance artifact including lineage data.

FIG. 6 illustrates commit-blocking and commit-non-blocking synchronization modes.

FIG. 7 illustrates temporal execution modes including real-time, batch, and replay processing.

FIG. 8 illustrates distributed deployment across heterogeneous systems.

FIG. 9 illustrates compliant content transformation and output generation.

FIG. 10 illustrates conflict detection and projected-outcome ranking.

### DETAILED DESCRIPTION OF THE INVENTION

Definitions. As used herein, a structured intermediate representation refers to a normalized, machine-interpretable data structure generated from input data and independent of a native source data model. Governing criteria refers to machine-evaluable rule constructs including jurisdictional, organizational, contractual, regulatory, operational, or risk-based constraints. A resolution state refers to a machine-determined evaluation outcome representing an authorized, conditioned, denied, escalated, or modified system state. A governance artifact refers to a machine-readable data object encoding the resolution state together with lineage data sufficient to enable deterministic reconstruction of the evaluation.

Core Processing Pipeline. Input data originating from one or more source systems is received through one or more interfaces. The input data is transformed into the structured intermediate representation through normalization, tokenization, schema mapping, or other transformation processes. Contextual attributes are extracted and used to dynamically select governing criteria.

Resolution-State Generation. Processing circuitry applies the selected governing criteria to the structured intermediate representation to produce a resolution state.

Governance Artifact Encoding. A governance artifact is generated that encodes the resolution state, identifiers of the governing criteria applied, contextual attributes, timestamps, system identifiers, and lineage data.

Commit Synchronization Modes. The governance evaluation architecture operates in a commit-blocking mode and in a commit-non-blocking mode.

Temporal-Agnostic Execution. Evaluation may occur in real time, batch processing, event-driven execution, replay, simulation, or predictive analysis.

Distributed and Heterogeneous Deployment. The architecture is interoperable across multiple interconnected systems and deployment topologies.

Transformation and Compliant Output. Based on the resolution state, controlled content may be automatically modified or routed for escalation.

Conflict Detection and Ranking. Where multiple governing criteria apply, conflicts are detected and multiple candidate resolution states are generated and ranked.

Replay, Simulation, and Remediation. Governance artifacts enable deterministic replay of prior evaluations under original or modified governing criteria.

Technical Effect. The disclosed architecture provides a topology-independent governance control layer capable of producing deterministic, machine-determined resolution states across heterogeneous systems.

The governance evaluation operations described herein are performed by machine execution of stored instructions and produce machine-determined resolution states that condition commit-capable state transition and data transformation and therefore cannot be performed as a mental process.

Topology independence is achieved by performing governance evaluation on the structured intermediate representation rather than on a native system data model.

Deterministic replay is enabled by storing the governing-criteria version identifiers, contextual attributes, and evaluation inputs in association with the governance artifact.

The structured intermediate representation may comprise a canonical schema, tokenized representation, normalized graph structure, or other machine-interpretable format that is independent of a native source data model.

The governing criteria may be stored in versioned data structures comprising machine-readable rule expressions, resolution state graphs, constraint models, policy objects, or combinations thereof.

As used herein, an engine, module, or component refers to a machine-implemented construct comprising processing circuitry and memory storing executable instructions configured to perform the recited operations and is not limited to a purely functional abstraction.

As used herein, processing circuitry may comprise one or more processors, microprocessors, controllers, application-specific integrated circuits (ASICs), field-programmable gate arrays (FPGAs), graphics processing units (GPUs), virtualized compute instances, or any combination thereof, and may be implemented in centralized, distributed, cloud-based, edge-based, or hybrid environments.

In one embodiment, governance evaluation is performed according to a deterministic machine-execution sequence initiated in response to receipt of an input event originating from a source system, the input event comprising controlled content and one or more associated source identifiers.

Processing circuitry generates a structured intermediate representation from the input event by performing at least one of schema normalization, tokenization, field extraction, graph generation, or canonical mapping, the structured intermediate representation being independent of a native data model of the source system.

Contextual attributes are extracted from at least one of the input event and the structured intermediate representation, the contextual attributes including one or more of jurisdictional indicators, organizational identifiers, temporal attributes, content classification indicators, system-origin contextual attributes, or commit-capable state transition-state indicators.

The processing circuitry retrieves governing criteria from a versioned governing-criteria data structure based on the contextual attributes, the retrieved governing criteria including a version identifier and a machine-evaluable rule construct.

The processing circuitry applies the retrieved governing criteria to the structured intermediate representation to generate a resolution state object representing at least one of an authorized state, a conditioned state, a denied state, or an escalated state.

In a commit-blocking synchronization mode, the resolution state object is transmitted to a downstream system as a commit authorization signal prior to finalization of a commit-capable state transition.

In a commit-non-blocking synchronization mode, the resolution state object is generated without preventing execution of the commit-capable state transition and is stored for subsequent replay, audit, remediation, or simulation.

A governance artifact is generated as a machine-readable data object that encodes the resolution state object together with at least one of the contextual attributes, the version identifier of the governing criteria, a timestamp, a source lineage identifier, or an evaluation input identifier.

The governance artifact is stored in a tamper-evident data structure configured to enable deterministic reconstruction of the evaluation by reapplying the version-identified governing criteria to the structured intermediate representation.

In embodiments in which multiple governing criteria apply to different portions of the structured intermediate representation, the processing circuitry generates multiple candidate resolution state objects and performs conflict detection to generate a unified resolution state.

The unified resolution state is transmitted to at least one external system as a machine-readable control output that conditions at least one of content transformation, commit authorization, escalation routing, or execution-state modification.

In a replay mode, the processing circuitry reconstructs a prior evaluation by retrieving the governance artifact and re-executing the governance evaluation sequence.

In a simulation mode, the processing circuitry applies a modified version of the governing criteria to generate an alternate resolution state.

Conventional rule-evaluation and compliance systems are implemented within application-specific execution environments and operate directly on native data models of those environments. As a result, such systems require duplication of rule logic across multiple platforms, produce inconsistent governance outcomes, and do not support deterministic reconstruction of prior evaluations across heterogeneous systems.

In contrast, the disclosed governance evaluation architecture performs machine execution of governing criteria on a structured intermediate representation that is independent of a native source data model. This topology-independent evaluation enables a single governing-criteria implementation to be applied across multiple disparate systems without modification of the governing criteria.

By generating a machine-determined resolution state and a machine-readable governance artifact that encodes lineage data and governing-criteria version identifiers, the disclosed architecture enables deterministic replay of prior evaluations. Conventional systems that store only resolution states or log entries are unable to reproduce prior evaluation outcomes under the original governing conditions.

The use of version-identified governing criteria allows governance evaluation to be performed under historically accurate governing criterias and further allows simulation of alternate resolution states using modified governing criteria without modification of the underlying source systems.

The disclosed commit-blocking synchronization mode conditions finalization of a commit-capable state transition on generation of the resolution state. This provides machine-enforced governance at execution time rather than post-execution analysis. Conventional systems that perform post-event auditing or asynchronous validation do not control execution of the underlying operation.

The disclosed commit-non-blocking synchronization mode allows the governance evaluation to be performed without preventing execution of the underlying operation while still generating a governance artifact for replay, audit, remediation, or simulation. This dual-mode operation enables deployment in environments having different latency and control requirements.

The conflict-detection and candidate-resolution ranking operations enable simultaneous application of multiple governing criteria to different portions of the structured intermediate representation and generation of a unified resolution state. Conventional systems apply a single governing criteria to a single data model and do not generate multiple machine-determined candidate outcomes for ranking.

Because governance evaluation is performed on the structured intermediate representation rather than on native system data models, the disclosed architecture operates as a control layer that is independent of deployment topology and underlying application implementation. This allows insertion of the governance evaluation architecture into existing system environments without modification of the native execution logic of those systems.

The governance artifact functions as a machine-readable control output that conditions downstream system behavior, including at least one of commit authorization, content transformation, escalation routing, or execution-state modification. Conventional compliance systems generate reports or notifications that do not directly control execution of downstream commit-capable state transitions.

The disclosed architecture therefore provides a machine-implemented governance control mechanism that produces a technical effect in the operation of computing systems by conditioning execution of commit-capable state transitions, enabling deterministic replay of prior evaluations, and providing topology-independent governance across heterogeneous environments.

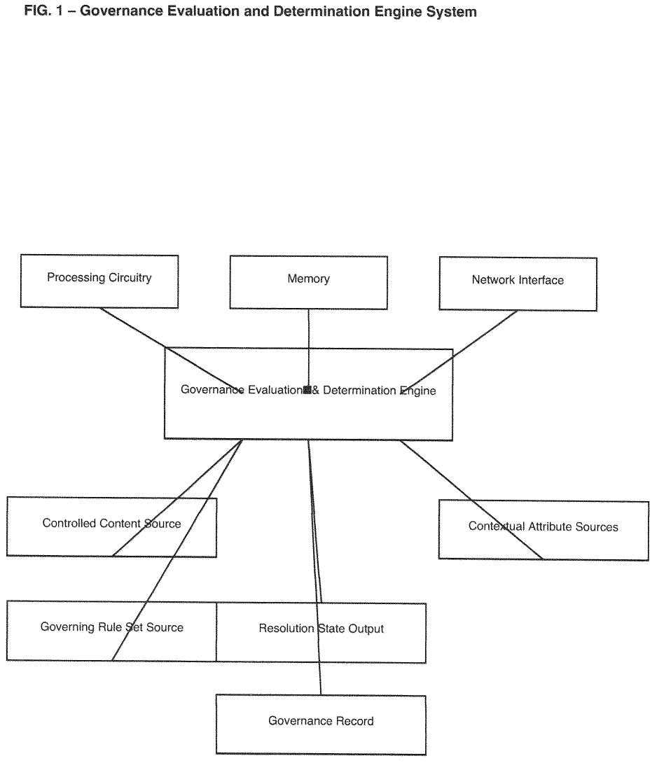

In one embodiment, the governance evaluation sequence corresponds to the functional components illustrated in the figures. FIG. 1 illustrates an example governance evaluation system including one or more source systems, processing circuitry, and memory storing executable instructions configured to perform the governance evaluation sequence.

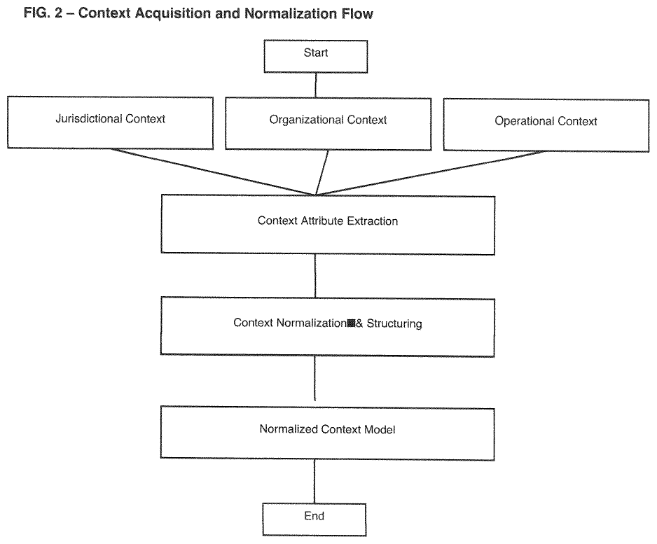

FIG. 2 corresponds to generation of the structured intermediate representation from the evaluation input object. The transformation operations illustrated in FIG. 2 are performed prior to application of governing criteria and produce a topology-independent data structure used in subsequent evaluation operations.

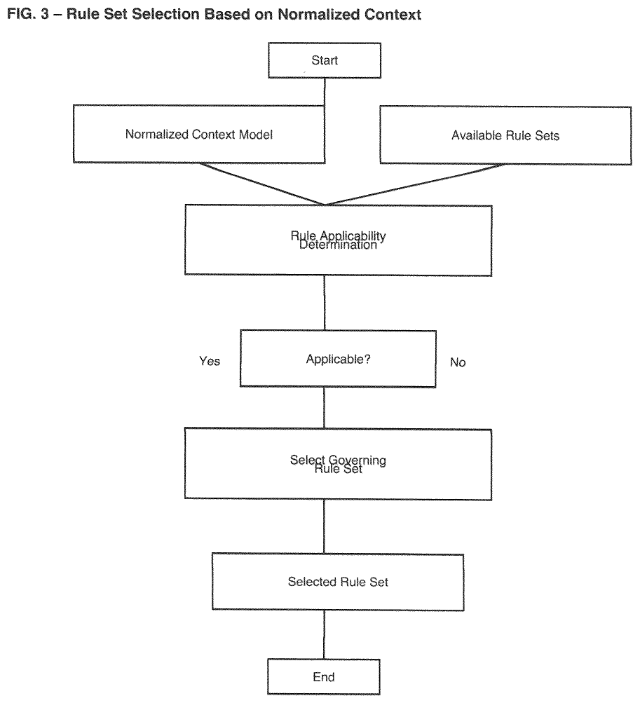

FIG. 3 corresponds to extraction of contextual attributes and dynamic selection of governing criteria. The contextual attributes illustrated in FIG. 3 are used to retrieve version-identified governing criteria from a governing-criteria data structure.

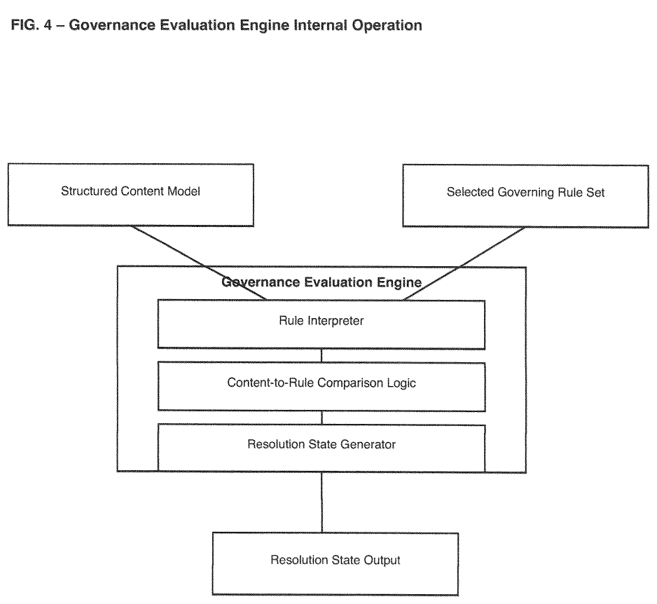

FIG. 4 corresponds to application of the selected governing criteria to the structured intermediate representation and generation of the resolution state object representing the machine-determined evaluation outcome.

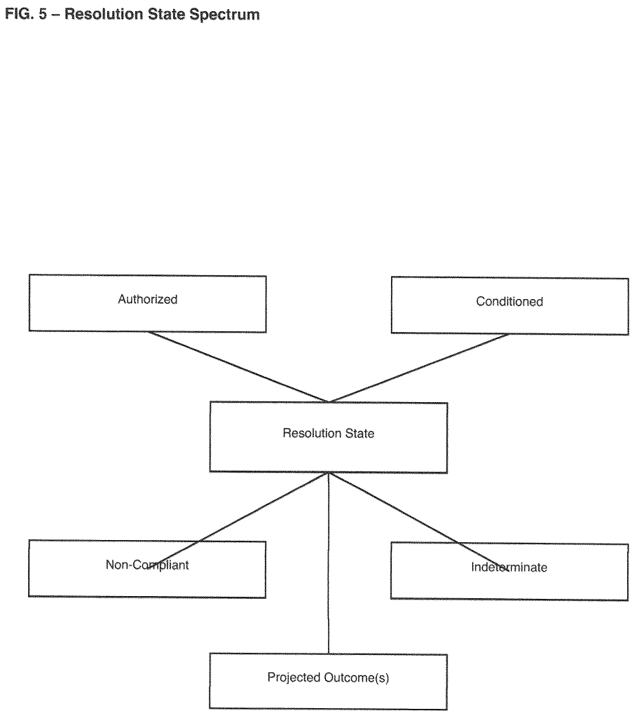

FIG. 5 corresponds to generation of the governance artifact. The governance artifact illustrated in FIG. 5 encodes at least the resolution state, governing-criteria identifiers, contextual attributes, and lineage data enabling deterministic reconstruction of the evaluation.

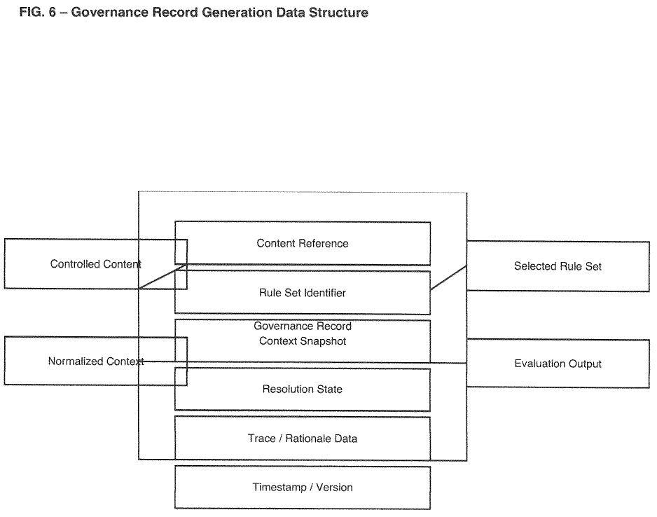

FIG. 6 corresponds to commit-blocking and commit-non-blocking synchronization modes. In the commit-blocking mode, the resolution state conditions finalization of a commit-capable state transition. In the commit-non-blocking mode, the governance artifact is generated without preventing execution of the commit-capable state transition.

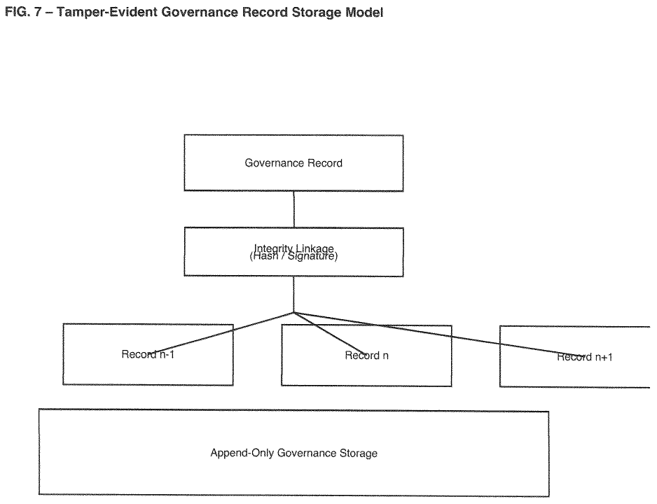

FIG. 7 corresponds to temporal execution modes including real-time execution, batch processing, replay, and simulation. In the replay mode, a prior evaluation is reconstructed using stored lineage data and version-identified governing criteria. In the simulation mode, a modified version of the governing criteria is applied to generate an alternate resolution state.

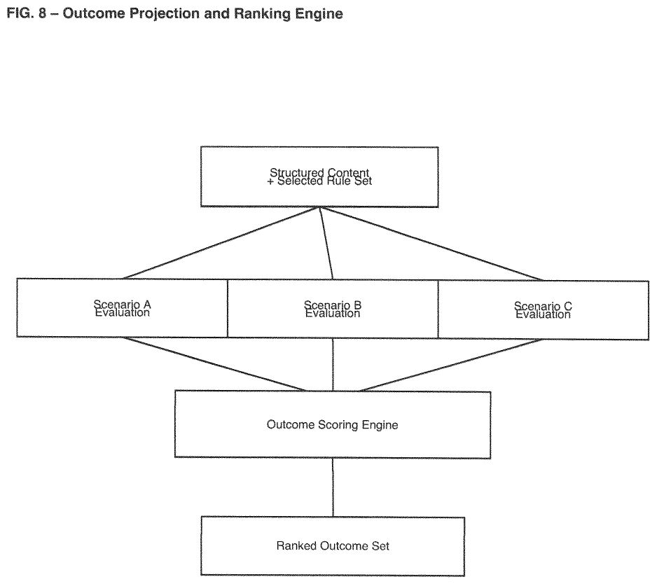

FIG. 8 corresponds to distributed deployment of the governance evaluation architecture across heterogeneous systems. The structured intermediate representation enables application of the governing criteria independent of native data models of the heterogeneous systems.

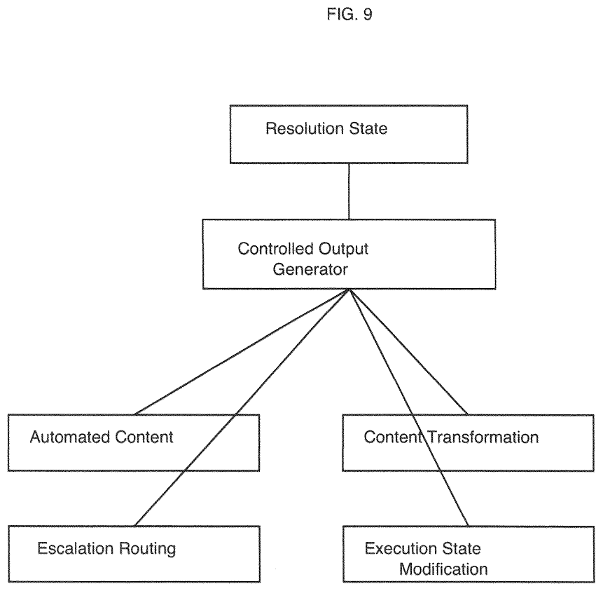

FIG. 9 corresponds to generation of a controlled output based on the resolution state, including at least one of automated content transformation, escalation routing, or execution-state modification.

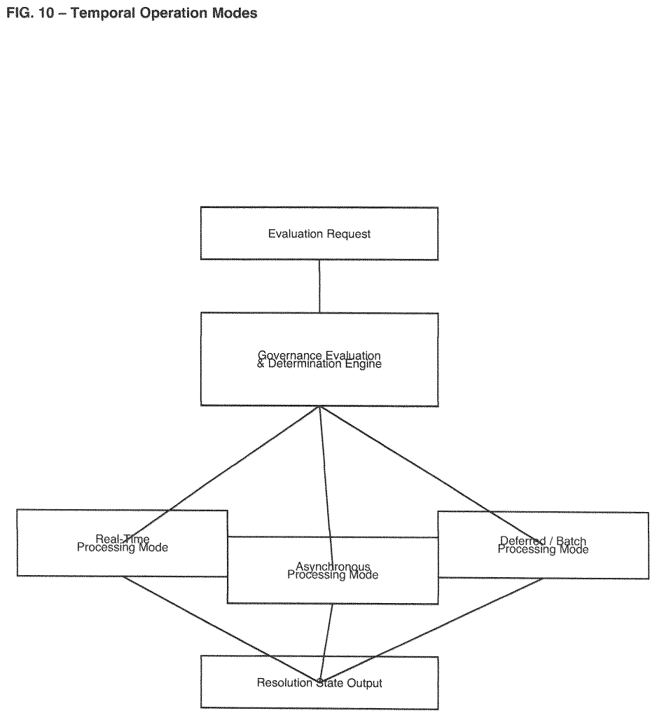

FIG. 10 corresponds to conflict detection and generation of multiple candidate resolution states and ranking of the candidate resolution states to produce a unified resolution state.

The correspondence between the governance evaluation sequence and the functional components illustrated in the figures enables the governance evaluation architecture to operate as a topology-independent control layer that conditions execution of commit-capable state transitions across heterogeneous execution environments.

As used throughout this specification, the terms “structured intermediate representation,” “governing criteria,” “resolution state,” “governance artifact,” “commit-capable state transition,” “contextual attributes,” and “version-identified governing criteria” refer to the respective data structures and machine-executable constructs described herein, and variations in phrasing are intended to refer to these same structures unless expressly distinguished.

The governance evaluation architecture is deployable in a plurality of execution arrangements and is not limited to a particular physical, logical, or network topology. In various embodiments, the processing circuitry configured to perform governance evaluation is implemented as at least one of an inline component within a request-processing path, an out-of-band evaluation service, a distributed evaluation node, a centralized control service, an edge-executed module, or a cloud-based execution environment.

In certain embodiments, governance evaluation is performed synchronously in association with a commit-capable state transition such that generation of the resolution state generates a machine-determined resolution state usable by a control system in governing a commit-capable state transition. In other embodiments, governance evaluation is performed asynchronously relative to the commit-capable state transition while still generating a governance artifact configured for replay, remediation, simulation, or subsequent evaluation and determination operations.

The governance evaluation architecture may be interposed between communicating systems, integrated within an application execution environment, implemented as a service accessible through an application programming interface, or deployed as a control layer operating across a plurality of heterogeneous systems without modification of native execution logic of the heterogeneous systems.

In distributed embodiments, portions of the governance evaluation sequence are performed by different processing nodes that operate on a common structured intermediate representation, and the resolution state is generated based on the combined evaluation of the governing criteria across the processing nodes.

Because governance evaluation is performed on the structured intermediate representation rather than on a native system data model, the governance evaluation architecture is relocatable within an execution environment without modification of the governing criteria, thereby enabling insertion, removal, or relocation of the governance evaluation architecture while preserving functional operation.

1. A governance evaluation system comprising processing circuitry and memory storing instructions that, when executed by the processing circuitry, cause the system to receive controlled content; detect a non-compliant condition in the controlled content; select a governing criteria based on one or more contextual attributes; determine a resolution state based on an evaluation of the controlled content against the governing criteria; generate a compliant content output based on the resolution state; and generate a governance record representing the evaluation and the resolution state.

2. The system of claim 1, wherein the controlled content is transformed into a structured intermediate representation prior to the evaluation.

3. The system of claim 1, wherein the governing criteria is version-specific.

4. The system of claim 3, wherein the governance record includes an identifier of the version-specific governing criteria.

5. The system of claim 1, wherein the compliant content output comprises an automated modification of the controlled content.

6. The system of claim 1, wherein the governance record is stored in a tamper-evident data structure.

7. The system of claim 6, wherein the governance record enables reconstruction of the evaluation.

8. The system of claim 1, wherein the evaluation is performed across multiple interconnected systems.

9. A governance evaluation architecture comprising processing circuitry and memory storing instructions that, when executed by the processing circuitry, cause the processing circuitry to receive input data originating from one or more source systems; generate a structured intermediate representation of the input data that is independent of a source data model; select governing criteria applicable to at least a portion of the structured intermediate representation based on one or more contextual attributes; apply the selected governing criteria to the structured intermediate representation to produce a resolution state representing a machine-determined evaluation outcome; and generate a machine-readable governance artifact.

10. The governance evaluation architecture of claim 9, wherein the governance artifact further encodes lineage data sufficient to enable deterministic reconstruction of the evaluation.

11. The governance evaluation architecture of claim 9, wherein different governing criteria are applied to different portions of the structured intermediate representation to produce a unified resolution state.

12. The governance evaluation architecture of claim 9, wherein the architecture operates in a commit-blocking mode.

13. The governance evaluation architecture of claim 9, wherein the architecture operates in a commit-non-blocking mode.

14. The governance evaluation architecture of claim 9, wherein the governing criteria are versioned.

15. The governance evaluation architecture of claim 9, wherein the architecture is operable independent of deployment topology.

16. A computer-implemented method comprising receiving controlled content; detecting a non-compliant condition; selecting a governing criteria; determining a resolution state; generating a compliant content output; and generating a governance record.

17. A non-transitory computer-readable medium storing instructions that, when executed by processing circuitry, cause the processing circuitry to perform the method of claim 16.

18. The system of claim 1, wherein the resolution state includes an escalation directive to an authorized reviewer.

19. The system of claim 1, further comprising generating a plurality of compliant content outputs and ranking the plurality of compliant content outputs based on a projected outcome model.

20. The system of claim 19, wherein the projected outcome model comprises one or more of regulatory exposure, financial impact, or contractual risk.
